(19) United States
(12) Patent Application Publication
(10) Pub. No.: US 2021/0146419 A1
(43) Pub. Date: May 20, 2021

(54) METHOD AND APPARATUS FOR MAKING FIN TUBE

(71) Applicant: Stefan LEUTLOFF, Luenen (DE)

(72) Inventor: Stefan LEUTLOFF, Luenen (DE)

(21) Appl. No.: 17/095,487

(22) Filed: Jan. 7, 2021

(30) Foreign Application Priority Data
Nov. 20, 2019 (DE) 102019131313.9

(51) Int. Cl. B21C 37/26; B23K 26/302; F28F 1/36

(52) U.S. Cl. CPC B21C 37/26; F28F 1/36; B23K 26/302

(57) ABSTRACT

Method for manufacturing a finned tube, in which a tube base body is finned on its outside, in particular helically, by a band, to which end the band is taken to the tube base body using a guide element and is attached to the base body, in particular by means of a laser beam, characterized in that the guide element is adjusted in particular in respect of its orientation relative to the tube base body during the attachment process.

The invention relates according to a first aspect to a method for manufacturing a finned tube.

Finned tubes of this kind usually have a tube base body, which is or is to be finned helically on its outside by at least one band. The band is attached, preferably welded by means of a laser, in the contact area of band and tube base body.

Such finned tubes are used in heat exchangers, for example, which play an important role in air-conditioning technology. They increase the efficiency of heating installations and thus reduce consumption and costs, due to which they play a crucial role in climate protection also. (Spiral) finned tubes can be combined for this purpose to form compact heat exchangers, for example.

The finned tubes are typically thin-walled, metal tube base bodies (of a substantially straight configuration) that have helical cooling fins to increase the surface area.

The density of cooling fins (measured in fins/unit of length) dictates the thermal properties here. A maximum possible slope is not always desirable, however, and this is why it is known to install finned tubes with slopes different from each other in (different) heat exchangers.

The constant fin slope of a tube is due here to the manufacturing method: the band forming the fins typically exists as coil or endless material and is led to the welding process via a guide (comprising guide rollers, for example). The transfer point of the guide, also termed delivery guide element, is formed statically in this case, while the tube base body rotates about its own axis and is moved axially in a linear manner.

Even if the method described functioned reliably in the past, the steady efforts to provide a method that produces finned tubes that can be used more variably continue.

The invention achieves this object according to a first aspect with the features of claim 1, in particular with those of the characterizing part, and is accordingly characterized in that the guide element is adjusted, in particular during the attachment process (preferably with regard to its arrangement and/or orientation relative to the tube base body).

In other words, the idea of the invention lies with configuring the transfer point of the guide adjustably, in particular with regard to its arrangement relative to the tube base body, and thus in particular not statically (as previously known from prior art).

In this way the band can be affixed to the tube base body when the latter is accelerated in that the guide element, by means of adjusting, adjusts the setting angle of the band to the (changing) speed of the tube base body.

In general terms, an adjustment of the guide element takes place depending on the speed (change) of the tube base body.

This speed can be the axial speed and/or the rotational speed of the tube base body.

The tube base body is conveyed in a corresponding conveyor system typically linearly, that is, in the axial direction, and preferably rotates about its own axis in this case.

In the method described above, the change of speed of the tube base body (in an axial direction) in particular leads to a change in the slope of the fins or of the affixed band in the area of an (individual) finned tube.

While it is only known from prior art to manufacture finned tubes with constant slopes, the method described makes it possible to manufacture a finned tube with a varying slope for the first time.

However, there were attempts by the applicant to achieve a change in slope purely by acceleration of the tube base body (with a static guide element). Nonetheless, these only had limited success as the attachment did not function smoothly.

It is only the adjustability of the guide element that ensures a smooth flow of attachment of the band to the tube base body in the case of a varying slope. Due to the adjustability, the guide element can thus track in particular the setting angle of the band on the tube during a (positive or negative) acceleration (axially and/or rotationally) of the tube base body.

Independently of a varying slope of the band fins, the adjustability during the finning process also brings other advantages, however, such as the possibility of reacting to changes in the flow of production or similar, or (if desired) changing the protrusion angle (in sections).

It is also possible in principle, however, that the guide element is adjusted not during the attachment process, but in a break in production, for example, for the purpose of better access to the attachment point or the tube base body for maintenance purposes or similar.

The adjustment takes place here typically automatically or in an automated manner, in particular after predetermined times or band or tube base body length displacements. It is also basically within the scope of the invention, however, that the adjustment takes place manually, this probably tending to be a less common case in practice.

The guide element according to the invention, which is adjustable, is preferably the guide element that is associated with the tube base body or with the contact of tube base body and band. Here the guide element transfers the band to the tube base body preferably without the band coming into contact with other elements in between/in the interim.

To this end the guide element can comprise in particular a deflection element, for example a rolling element in the manner of a roller or alternatively a static element in the manner of a guide surface. In particular, the guide element can have a sliding guide or similar.

It is essential for the invention that the guide element is adjustable so that, for example, the guide surface or the roller or similar can be adjusted so that the band has an altered orientation due to such an adjustment, especially with respect to the tube base body.

In particular, the guide element can be moved, that is the axis of a corresponding roller or the guide surface per se, for example. A translatory displacement preferably takes place, in particular a parallel shift, of the guide element (in particular of the axis). Alternatively or additionally, however, a rotation and/or tilting can take place.

The guide element can be formed open, for example U-shaped, or closed, thus rectangular, for example. This is not important for the invention.

It is especially preferable if the guide element is adjustable with regard to at least three degrees of freedom. This implementation can be achieved in particular in that the guide element is associated with a freely movable robot arm. It is preferably freely displaceable in space. On the other hand, guide elements that are only configured to be pivotable or rotatable, or are displaced linearly or tilted, are also within the scope of the invention. An adjustment with fewer than three degrees of freedom, for example with two degrees of freedom, is thus possible. In particular, an adjustment can also be effected only in one direction or in one plane.

The adjustment of the guide element advantageously leads to a change in the setting angle of the band on the tube base body.

This setting angle means in particular the angle here that defines the slope of the band on the tube base body, thus preferably the angle between the contact line of band and tube base body and a circle (ring) defining the circumference of the tube base body. Alternatively, said angle can also be defined as the angle between said contact line and the radial direction of the tube base body (in a plan view). It is thus not the angle between said contact line and the radial direction (protrusion angle) that is meant, which angle is typically 90 degrees on finned tubes (bands normally protrude perpendicularly from the fin surface).

Applications are also imaginable in principle, however, in which said protrusion angle is to be other than 90 degrees, and even this could be achieved if necessary by means of an adjustable guide element. This should not initially be explicitly excluded from the invention at any rate.

The attachment of the band to the tube base body is typically effected by means of a laser. Other suitable attachment methods are also covered by the invention, however. In particular, the use of several laser beams or lasers should not be ruled out, however, especially for the case that several (parallel) bands are arranged on the finned tube.

To this effect one band is typically associated with one tube base body. Implementations are also known, however, in which the tube base body has fins that consist of several (at least two) bands. These then run typically parallel helically around the tube base body.

The tube base body can typically consist of copper, aluminum or another suitable metal (in particular stainless steel). The fins can consist of the same material or of another suitable material (for example, stainless steel, copper, aluminum, titanium or similar).

In the method according to the invention, straight finned tubes are typically manufactured initially. These can later be processed further (for example, be cut or bent or similar).

In particular, finned tubes with an internal twist structure can also be manufactured using the method. In this case the method would then comprise a step of forming an internal twist structure on the tube base body, for example during, before or after the finning process. In particular, the internal twist fins or the vortex structure can be imprinted from the outside, for example in an embossing process or similar.

In the context of the present patent application, the number of fins per unit of length (of the tube base body) is understood in this case as the fin slope. This can be the number of fins per inch, for example, or the number of fins per centimeter or similar. The fins can belong to one band here or also to different bands (if several bands run in parallel around the tube base body).

According to a particularly preferred embodiment of the invention, it is provided that the guide element is adjusted between several main feed positions. In particular, a (different) fin slope can be associated with each main feed position.

If the tube base body is to be finned (initially) with a first fin slope, a first main feed position can be set, if a second slope is to be selected, a second main feed position etc. In particular, the guide element can be adjusted between the main feed positions during the attachment process, i.e. during the finning.

The positions assumed by the guide element between the main feed positions during the adjustment process can then be termed secondary feed positions. These serve here purely to transit from one main feed position to another main feed position, no stopping of the guide element then typically occurring in the secondary feed positions. The guide element consequently assumes the main feed position for a longer period, but the secondary feed positions purely transitionally, namely, to adjust between the main feed positions.

In the main feed positions, the guide element can be latchable, lockable or securable or similar.

The main feed positions are typically predeterminable and programmable to a robot arm, for example.

The secondary feed positions are then typically not additionally predetermined, but are necessarily “run across”/“run through” during the adjustment between main feed positions.

If a finned tube is to be produced, for example, which has a first slope in a first area and a second slope in a second area, the adjustment of the guide element can take place such that the guide element assumes a first main feed position during the finning of the first area and a second main feed position during the finning of the second area. The adjustment can thus take place in particular when a change of finning of the first area to the second area takes place. An acceleration of the tube base body (axially and/or rotationally) then also typically takes place in this case.

Two, three or even more main feed positions can be provided. The attachment element can be adjustable automatically and/or manually between the main feed positions. The guide element can also be transferred, however, from a main feed position completely to a servicing position or similar, for example, in which the tube base body is freely accessible, for example.

Alternatives in which the attachment element is continuously adjustable (and also lockable) are naturally also covered by the invention.

According to another advantageous configuration of the invention, this is characterized in that the guide element has a guide roller. Guide devices typically have several guide rollers. In this sense, the guide element can provide the last guide roller, for example, thus located “downstream” in the displacement direction of the band. The axis of the guide roller can typically be displaced and/or tilted to adjust the guide element.

Instead of a guide roller, an immovable guide surface can also be provided, however. This can also be configured to be displaceable in a translatory manner, for example.

One embodiment in which the guide element is arranged on a robot arm or a similar adjustment device has turned out to be particularly advantageous. A particularly variable adjustability of the guide element is possible in this way.

In this exemplary embodiment also, the guide element can have a guide roller, for example, or be formed by this.

Robot arms are sufficiently known from robot technology. They have the advantage here that the guide element is adjustable between an especially large number of positions, or is utilizable variably or programmable in its adjustability according to the requirements of the tube base body and the entire finning line.

In particular, a robot arm also enables a complete removal of the guide element, for example in the event of maintenance work. Various programs can also be provided for the robot arm, for example for different types of bands (especially with respect to the material, size, dimensions or similar).

According to a particularly advantageous configuration of the invention, it is provided that the next contact of a band section leaving the guide element is with the tube base body. In this context, the transportation of the band or band section from the guide element to the tube base body is typically effected contactless/through the air.

In other words, the guide element can be the last element that contacts the band in the band progression before it encounters the tube base body. It can be the element of the entire guide device that comes closest to the tube base body.

The methods described can be carried out in particular by means of an inventive device according to claim 7. Said device accordingly comprises a correspondingly adjustable guide element. The guide element can be part of an adjusting device, for example, or can be adjustable by an adjusting device. In particular, a robot arm or similar can naturally also be part of the adjusting device, just like the aforesaid features such as rollers, guide surfaces or similar.

Let it be pointed out here that with regard to the device also, all the above advantages and configurations described with regard to the described method are to be considered disclosed. Purely for reasons of the clarity of the application, these advantages are not repeated again at this point.

Finally, the invention achieves the object also by a finned tube according to claim 8, which can be manufactured in particular by one of the described methods or one of the described devices.

This finned tube is accordingly characterized in particular in that it has a variable fin slope.

In other words, the finned tube according to the invention has at least a first section with a first fin slope and a second section with a second, different fin slope. The finned tube can naturally have other sections or areas with the same or other fin slopes.

In this case, however, said areas typically have the same band, or if several bands are used, all areas have the same bands. In other words, the band or bands extend over the entire finned tube and thus over all said areas.

For the finned tube according to the invention also, the advantages and configurations described in connection with the above method (and also with the described device) are to be considered as disclosed.

In particular, reference is made to the material composition of tube base body and/or band material described above.

According to a particularly advantageous configuration of the invention, the finned tube has several areas with a substantially homogeneous fin slope, which is different, however, from the fin slope of at least one other area. In this sense, even more than two areas with different fin slopes can naturally also be provided.

Substantially homogeneous in this case means that the area has a fin slope that is substantially remains the same. Due to manufacturing intolerances the fins can naturally have minimally different spacings from one another here. These should be negligible compared with the spacing of the fins in another area, however.

It should be pointed out in particular that in the boundary region between two areas, a transition area can naturally arise, as production dictates that the fin slope is not steplessly adjustable from one value to the other but usually changes continuously over the short transition area.

As already described above, the fins preferably protrude from the fin surface at a 90 degree angle (protrusion angle).

Alternatively to the configuration with several areas of different fin slope, it is self-evident, however, that configurations of finned tubes with a continuously varying fin slope are within the scope of the invention (for example, the function of the rise in the fin slope can even be linear over the tube length or similar).

Many finned tubes are also imaginable with areas that are repeated following their configuration (thus a first area with an increasing or decreasing or constant fin slope and then—or further away—a second or more identical areas).

Finally, it can be provided advantageously according to the invention that the finned tube has a monotonic change in fin slope. This can apply both to a continuously varying fin slope and to finned tubes with (discrete) areas of a fin slope that is homogeneous.

In particular, the fin slope can change in a strictly monotonic manner, thus can decrease or increase continuously over the finned tube length.

In the configuration with different areas of homogeneous fin slope in particular, however, a change in fin slope that is not strict, but is monotonic, can be present, for example if a first area is assumed that has a lower fin slope and a second area with a higher fin slope (if applicable further areas with respectively higher fin slopes).

Alternatively, however, finned tubes without a monotonic change in fin slope are also within the scope of the invention, for example those in which the slope increases initially and then decreases again or vice versa.

A configuration of the finned tube can also be provided advantageously according to the invention in which the finned tube has more than one band and the fin slope varies despite this. In particular, the bands are arranged substantially parallel in this case and thus the slope of the at least two bands also varies (over the length of the finned tube) substantially identically.

This is necessary in particular so that the individual bands do not cross or obstruct one another.

Further advantages of the invention result from the subclaims, which may not be cited, and from the description of the figures that now follows.

Shown here in the figures:

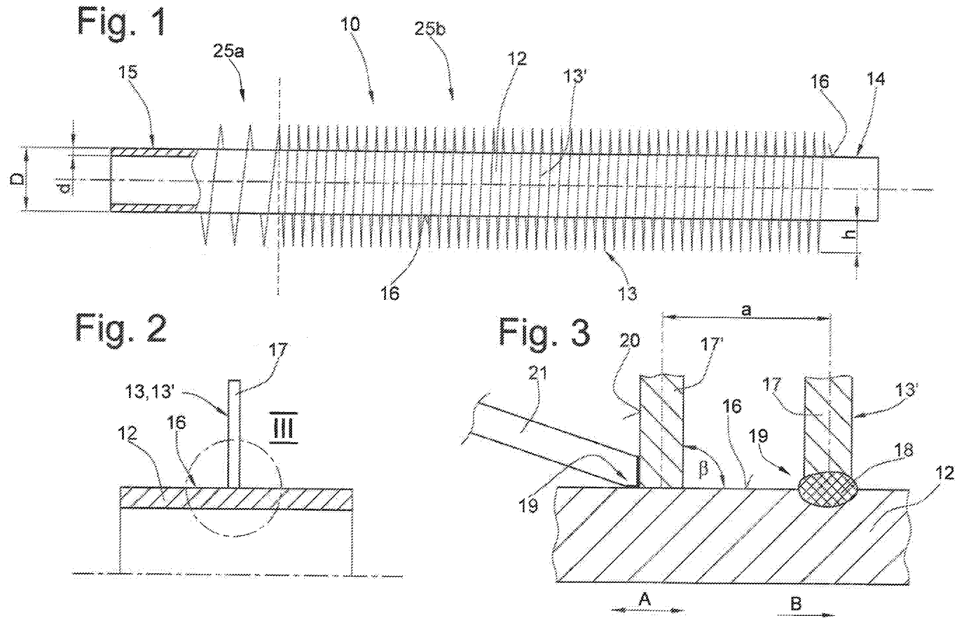

FIG. 1 in a highly schematic partial section in a lateral view, a finned tube according to the invention in a straight or as yet unshaped implementation with two areas of different fin slope,

FIG. 2 a likewise schematic, enlarged section of a finned tube according to the invention showing a single fin,

FIG. 3 the section according to the circle III in FIG. 2 in an enlarged representation with the addition of another, not yet welded fin to the left of the fin already attached in FIG. 2,

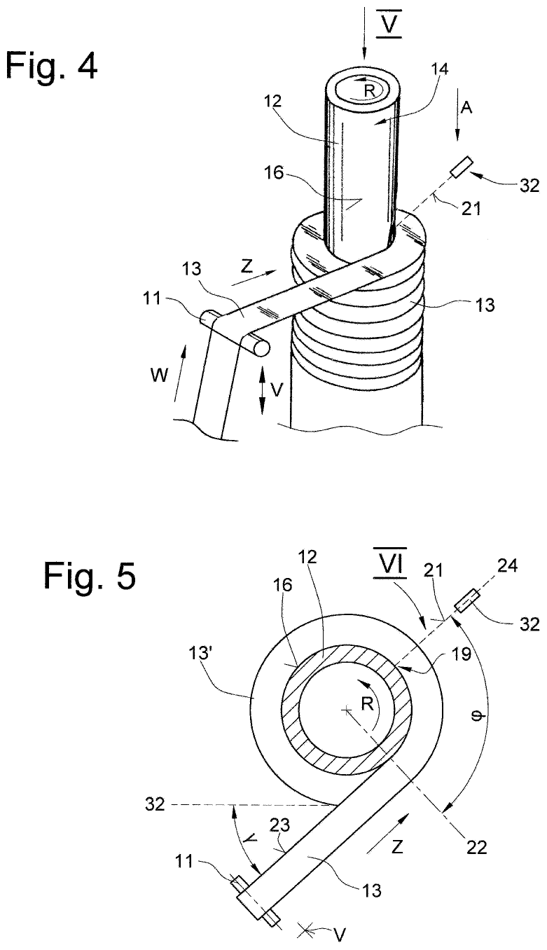

FIG. 4 in a highly schematic view in perspective, a winding process according to the invention of a band onto a tube base body with the depiction of a guide element formed by way of example as a roller,

FIG. 5 the arrangement according to FIG. 4 in a view roughly according to view arrow V in FIG. 4 in a highly schematic plan view,

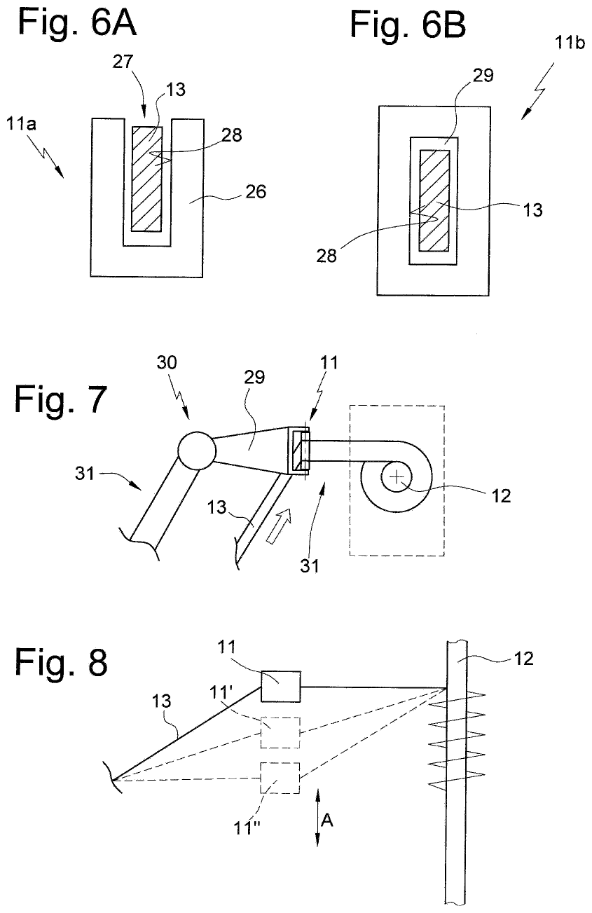

FIG. 6A a slightly modified embodiment of guide elements, which in particular corresponds to no roller guide, namely in the manner of sliding guides in a highly schematic (sectional) front view,

FIG. 6B another slightly modified embodiment of guide elements, which in particular corresponds to no roller guide, namely in the manner of a sliding guide in a highly schematic (sectional front view,

FIG. 7 in a highly schematic lateral view, a guide element arranged on a robot arm during the finning process,

FIG. 8 in a highly schematic plan view, a basic diagram of a guide element, which is only indicated, in three different main feed positions, and

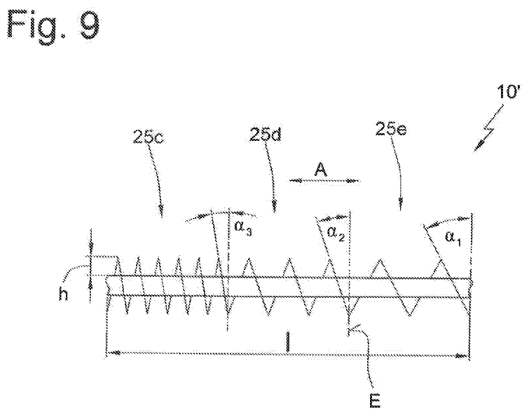

FIG. 9 in a lateral view, roughly according to FIG. 1, but truncated and not in partial section, another finned tube according to the invention with three areas of different fin slope.

It should be stated in advance of the following description of the figures that identical or comparable components are provided if necessary with identical reference signs, in some cases with the addition of small letters or apostrophes. The same also applies to the subsequent claims.

FIG. 1 shows first an already manufactured finned tube 10 according to the invention, which has basically been produced from two separate pieces. First a tube base body 12 is provided, which is formed as a straight, round tube. Wound helically around the base body 12 is a copper band 13 (alternatively an aluminum band or another band), which is welded onto the tube base body 12. The band 13 thus hereby forms an “endless” structure of fins 13′ (the structure of the fins 13′ naturally actually having a finite, fixed length; the fin structure is formed continuously, in other words).

As shown in FIG. 1, the band 13 leaves the ends 14 and 15 of the tube base body 12 free and is welded on the surface 16 of the tube base body 12. As is apparent in particular at the left-hand end 15 of the tube base body in the partly transparent depiction, this is formed hollow with a wall thickness d and a diameter D. The fin 13′ here has a fin height h.

FIG. 1 clarifies here that the finned tube 10 is a finned tube with a varying fin slope. Thus two areas 25a and 25b in particular are provided on the finned tube 10. While area 25b (the larger in the exemplary embodiment) has a relatively high fin slope, the area 25a has a fin slope that is only half as high. In other words, the spacing a between the fins 13′ in area 25b is only half as great as the spacing of the fins 13′ in area 25a.

An effect of this kind can be achieved in particular in that the axial/feed rate and/or the rotational speed of the tube base body 12 varies during finning. So that the band 13 does not tear in this case, an adjustable guide element 11 in particular is used for this, as will be described later in greater detail. The basic attachment of the band 13 to the base body 12 is now explained in greater detail on the basis of FIGS. 2 and 3.

Here FIG. 2 shows first in a purely schematic, partial-section depiction the enlarged individual depiction of a cross section 17 of an already welded fin 13′. The fin 13′ is welded to the tube surface 16 in the area depicted.

The right-hand area of FIG. 3 shows said fin 13′ in an already welded state. The already solidified melt 18 is recognizable here in FIG. 3 in the contact region 19 between tube base body 12 and band 13. The melt 18 consists proportionally of material of both the tube base body 12 and of the band 13 or the fin 13′ (on its underside).

The fin 13′ is formed roughly rectangular in cross section for this purpose.

The fin 13′ shown on the right of FIG. 3 is located in finning direction B (as an already fixed section) further forward than a cross section 17′ of another fin likewise depicted in FIG. 3. This cross section 17′ of the other fin and of the band 13 is welded in FIG. 3 precisely in the contact region 19 (which is formed substantially L-shaped on account of the tube surface 16, which is straight in cross section, and the straight lateral edge 20 of the fin).

To this end a laser beam 21 of a laser, not yet shown in FIG. 3, falls onto the contact region 19. The laser beam 21 here irradiates both material of the band 13 and of the cross section 17′ as well as material of the tube base body 12, in particular on its surface 16.

Since the cross section 17 of the band 13 is located in the finning direction B ahead of the cross section 17′, the left cross section according to FIG. 3 represents the state of welding of a section of the band 13, so to speak, and the right side according to FIG. 3 then represents the finished, welded state of a section of the band 13. Further sections of the band/fins would naturally follow in particular in finning direction B (and thus already welded) with a defined fin slope.

FIG. 4 illustrates in a perspective view, which is also schematic, however, the wrapping of the tube base body 12 with the band 13. It is to be gathered from FIG. 4 here that the band 13 runs finally in a straight line, substantially along a feed direction Z, toward the tube base body 12 and then contacts this tangentially on its surface 16.

Before the band 13 is guided in feed direction Z, however, it runs as shown in FIG. 4 initially along another unwinding direction W. Here it is deflected by a guide element 11 formed as a roller, namely from direction W to direction Z. The guide element 11 according to FIGS. 4 and 5 is thus formed as a guide roller. This guide element 11 is typically a constituent here of a guide device, not otherwise shown, for the band 13.

The special feature according to the invention now consists in the fact that this guide element 11 is adjustable, in the exemplary embodiment according to FIGS. 4 and 5 along an in particular linear adjustment direction V, for example. This adjustability of the guide element 11 along the adjusting direction V facilitates here in particular an adaptation to the change in displacement speed of the tube base body 12 in axial direction A and/or rotation direction R.

Let it be noted purely for the sake of completeness that a corresponding guide device actually has more than just one deflection element in practice in order to be able to supply the band from a reservoir or “coil” targetedly to the tube base body 12.

The tube base body 12 is—although this is not depicted—chucked in order to drive this rotating in rotation direction R and axially in axial direction A. The tube base body 12 can carry the band 13 along during this drive and unwind this, for example from a stock roll (“coil”) or a plate or bed (likewise not shown) in a directed manner and under the influence of a defined tensile and braking force. In addition, a drive can also be provided for the stock roll (for example, a spool drive).

On account of this tensile force and any feed movement of the band 13 that is present, the band 13 is acted upon continuously and progressively on the surface 16 of the tube base body 12. The impact commences as shown in FIG. 5 approximately from a region identified there by a radial axis 22.

From this region onward, therefore, the band 13 lies with its underside 23 in contact with the surface 16 of the tube base body 12. In consequence of the rotational movement in rotation direction R, the band 13 then runs in contact with the surface 16 of the tube base body 12 across an angular region f with the tube base body 12 before it is welded to the tube base body 12 in the area of a radial axis designated 24 by a laser beam 21.

The laser beam 21 is generated by a laser 32, which is depicted only very schematically. This laser 32 can provide a flexible supply here, which enables an ideal approach to the contact region 19 to be irradiated.

While the inventive guide element 11 according to FIGS. 4 and 5 is a guide element formed in the manner of a guide roller, FIGS. 6A and 6B show alternative configurations 11a and 11b of a guide element according to the invention.

Thus FIGS. 6A and 6B are intended to illustrate in particular that the guide element itself does not have to have any moving parts at all, for example no guide roller: with this in mind FIG. 6B illustrates that the guide element 11a can be formed as a roughly fork-shaped body 26 in cross section, for example, which provides a motion link 27 for guiding the band 13. The surfaces limiting the motion link 27 can accordingly also be termed guide surfaces 28.

An alternative configuration is shown in FIG. 6B, in which the guide element 11b is formed substantially closed, the band 13 therefore being guided through an opening 29 (or closed motion link). This closed motion link 29 can also be limited here by corresponding guide surfaces 28.

Entirely independently of whether the guide element is formed with or without guide rollers, the adjustability of the guide element is crucial for the invention: in all cases according to the invention, the guide element is adjustable (relative to the tube base body), for example pivotable or advantageously movable in a linear or translatory manner.

Let it be pointed out with this in mind that a guide roller of the guide element 11 does not yet form an adjustable guide element. On the contrary, if a guide roller is present, it is important for adjustability that the guide roller or its axis is adjustable or movable (for example, can experience a parallel movement). In this light, FIG. 4 already indicates a parallel movement or linear movement of the axis of the guide element 11 in the manner of a guide roller. This movement then typically leads (together with a change in speed of the tube base body 12) to a change in the slope of the fins.

In other words, a change in the (axial and/or rotational) speed of the tube base body 12 to achieve a different fin slope can be supported or cushioned by an adjustment of the guide element, in particular in the sense that any tensions arising due to the change in speed can be relieved.

FIG. 7 shows a particularly advantageous configuration of the invention. Here a guide element 11 (with or without guide roller), not shown in greater detail, is arranged at the end of a part 29 of a robot arm 30. This robot arm 30 can be a typical robot arm as is known from robotics or robot automation. In particular, articulation points can be provided between the individual parts (29 and 31 in the exemplary embodiment). Additional joints can likewise be provided at the end of the final part 29 also, thus substantially in the region of the guide element 11, for example (not explicitly depicted).

The arrangement of the guide element 11 on a robot arm makes it possible/easier to produce the finned tubes according to the invention here. In particular, adjustment can take place during finning, namely in the case that a change of speed (rotational or in an axial direction) of the tube base body 12 to be finned takes place to achieve a change in the fin slope, for example. No mount or clamping device for the tube base body 12 is depicted in FIG. 7. Such an apparatus is only indicated by a dashed box.

The robot arm 30 has other advantages also, namely that in a break in production or similar, for example, the guide element 11 can be moved away from the region 31 before the transition point of the band 13 to the tube base body 12 for servicing purposes, for example (the robot arm 30 can consequently be pivoted for this).

FIG. 8 then illustrates how the guide element 11 is adjustable purely by way of example between three main feed positions. The guide element 11 shown in continuous lines in the plan view according to FIG. 8 is thus adjustable via an adjustment device, which is not depicted (this does not necessarily have to be a robot arm), in a linear manner in this exemplary embodiment, for example in or opposite to axial direction A, which corresponds to the adjustment direction V.

Two other main feed positions 11′ and 11″ of the guide element are accordingly indicated by dashed lines in FIG. 8, which illustrate in particular that the band 13 in all three cases depicted meets the tube base body 12 at a slightly different angle (in this case FIG. 8 shows in particular an excessive or exaggerated depiction, however). This other impact angle can ensure in particular here an equalization, relief or approximation of tensions that can arise when changing the band slope during the finning process.

The angle to be changed is typically not the angle at which the band 13 or the fin 13′ protrudes from the surface 16 of the tube base body 12: this angle β, as shown in FIG. 3, is typically around 90 degrees, to be precise, and is here termed “protrusion angle”. It is typically constant.

In FIG. 9 this is rather the angle at which the band either deviates in plan view from the axial direction A of the tube base body 12 or (what is designated by angle α in FIG. 9) the angle by which the band or the fin (or its projection) deviates from the orthogonal plane E of the axial direction A.

FIG. 9 shows here another example of a finned tube 10′ according to the invention, which does not have just two areas 25a and 25b of different slope compared with the finned tube 10 according to FIG. 1, however, but rather three different areas 25c, 25d and 25e.

FIG. 9 thus illustrates that the finned tube according to the invention can have more than two different fin slopes or more than two different areas with homogeneous fin slope. In the exemplary embodiment according to FIG. 9, the area 25c has a high fin slope, the area 25d has a medium fin slope and the area 25e has the lowest fin slope. The angle α₁ is accordingly greater than the angle α₂ and this in turn is greater than the angle α₃ (α thus identifying the angle of deviation of the fin from the orthogonal plane E to the axial direction A or from the tube circumference).

The converse would apply in the case of the deviation angle of the fin relative to axial direction A, which angle is not shown (this would be smallest for the area 25e, greatest for the area 25c). Both types of angle are basically suitable, however, for illustrating the change with deviating fin slope.

The fin slope of the tube 10′ according to FIG. 9 is thus increasing (not strictly) monotonic from left to right.

What are not illustrated but are likewise within the scope of the invention are also finned tubes that have several areas of the same slope separated from one another (for example, a first area of a first slope, a second area of a second slope and a third area of a first slope again).

1. Method for manufacturing a finned tube (10), in which a tube base body (12) is finned on its outside (16), in particular helically, by a band (13), for which purpose the band (13) is guided toward the tube base body (12) using a guide element (11) and is attached to the base body, in particular by means of a laser beam (21), characterized in that the guide element (11) is adjusted, preferably in respect of its arrangement and/or orientation relative to the tube base body (12), in particular during the attachment process.

2. Method according to claim 1, characterized in that the guide element (11) is adjusted between several, preferably at least three, main feed positions, which each respectively define in particular a different band slope.

3. Method according to one of the preceding claims, characterized in that the guide element (11) comprises a guide roller, in particular such that its axis is displaced in a translatory manner and/or tilted to adjust the guide element.

4. Method according to any one of the preceding claims, characterized in that the guide element (11) is arranged on a robot arm (30).

5. Method according to any one of the preceding claims, characterized in that the next contact of a section of the band leaving the guide element (11) is with the tube base body (12).

6. Method according to any one of the preceding claims, characterized in that the tube base body (12) experiences a change of speed, in particular of axial or rotational speed, during the attachment process.

7. Device for manufacturing a finned tube (10) with a band (13) attached to the outside (16) of a tube base body (12), in particular for performing a method according to any one of the preceding claims, characterized in that the device has a guide element (11) that is adjustable, in particular during the attachment process.

8. Finned tube (10), in particular manufactured according to a method according to any one of claims 1 to 6, comprising a tube base body (12), in particular of copper or aluminum, which is finned on its outside (16), in particular helically, by at least one band (13), characterized in that the finned tube (10) has a varying fin slope.

9. Finned tube (10) according to claim 8, characterized in that the finned tube (10) has several, in particular discrete, areas (25) with a fin slope that is substantially homogeneous, but different from one another, preferably precisely two areas (25a, 25b) or at least three areas (25c, 25d, 25e).

10. Finned tube (10) according to claim 8 or 9, characterized in that the finned tube (10) has a monotonic, in particular strictly monotonic, preferably substantially linear change in fin slope.
